(19) United States
(12) Patent Application Publication
(10) Pub. No.: US 2009/0083496 A1
(43) Pub. Date: Mar. 26, 2009

(54) Method for Improved Performance With New Buffers on NUMA Systems

(76) Inventor: David L. Stevens, JR., Hillsboro, OR (US)

Correspondence Address: LIEBERMAN & BRANDSDORFER, LLC, 802 STILL CREEK LANE, GAITHERSBURG, MD, 20878, US

(21) Appl. No.: 11/861,333

(22) Filed: Sep. 26, 2007

(51) Int. Cl. G06F 12/06

(52) U.S. Cl. 711/144; 711/E12.078

(57) ABSTRACT

A method and apparatus are provided for managing buffer allocations in a multiple processor computer system. A cache invalidate command is issued in response to a buffer allocation from a remote processor, wherein the cache lines present in the buffer allocation must be invalidated by the remote processor before data can be stored therein. The remote invalidate command specifies multiple cache lines to support invalidation of the specified multiple cache lines in a single communication. Following confirmation of invalidation of the cache lines, the processing to which the buffer has been allocated can write data to the invalidated cache lines.

### BACKGROUND OF THE INVENTION

1. Technical Field

This invention relates to a buffer in a multiprocessing computer system and management of cache lines in the buffer. More specifically, the invention relates to invalidating cache lines in the buffer in an efficient manner that mitigates multiple calls across a network.

2. Description of the Prior Art

Multiprocessor systems by definition contain multiple processors, also referred to herein as CPUs that can execute multiple processes or multiple threads within a single process simultaneously in a manner known as parallel computing. In general, multiprocessor systems execute multiple processes or threads faster than conventional uniprocessor systems that can execute programs sequentially. The actual performance advantage is a function of a number of factors, including the degree to which parts of a multithreaded process and/or multiple distinct processes can be executed in parallel and the architecture of the particular multiprocessor system at hand. The degree to which processes can be executed in parallel depends, in part, on the extent to which they compete for exclusive access to shared memory resources.

The architecture of shared memory multiprocessor systems may be classified by how their memory is physically organized. In distributed shared memory (DSM) machines, the memory is divided into modules physically placed near one or more processors, typically on a processor node. Although all of the memory modules are globally accessible, a processor can access its own local memory faster than memory local to another processor or memory shared between processors. Because the memory access time differs based on memory location, such systems are also called non-uniform memory access (NUMA) machines. Accordingly, in a NUMA machine, each processor has its own local memory, but can also access memory owned by other processors.

On the other hand, in centralized shared memory machines the memory is physically in one location. Centralized shared memory computers are called uniform memory access (UMA) machines because the memory is equidistant in time for each of the processors. Both forms of memory organization typically use high-speed caches in conjunction with main memory to reduce execution time.

The use of NUMA architecture to increase performance is not restricted to NUMA machines. A subset of processors in an UMA machine may share a cache. In such an arrangement, even though the memory is equidistant from all processors, data can circulate among the cache sharing processors faster, i.e. with lower latency, than among the other processors in the machine. Algorithms that enhance the performance of NUMA machines can thus be applied to any multiprocessor system that has a subset of processors with lower latencies. These include not only the noted NUMA and shared-cache machines, but also machines where multiple processors share a set of bus-interface logic as well as machines with interconnects to the processors.

A buffer is a region of memory used to temporarily hold data. When one or more local buffers are exhausted, a new buffer allocation that may have been previously owned by a remote processor may be requested from global memory. On NUMA systems, effort is taken to allocate buffers in memory local to the processor doing the allocation. It is known in the art that a buffer contains one or more cache lines, i.e. portions of main memory stored in cache memory for faster access by a processor. Cache memory stores data frequently or recently executed by their associated processors. Each cache line corresponds to a block of main memory, usually a small fixed size (e.g. 32 bytes). Valid cache entries for larger blocks of memory may be represented by a main memory starting address and a cache line index indicating a number of cache lines from that starting address to an indicated cache line. Each cache line has an associated state indicating whether the cache memory copy is valid, or whether a remote processor's cache contains the most recent contents of that cache line.

In the prior art, each cache line in the new buffer allocation must be invalidated by a remote cache-invalidate, i.e. a cache invalidate for the remote processor that previously owned the cache, before the cache line in the new buffer allocation can be written to by the requesting processor for the first time. A new buffer allocation most recently written by a remote processor contains cached data in the remote processor's cache. This cached data is irrelevant to the processor requesting the new buffer, as the data in the cache is old data that is not required to support the prior processor or the processor that requested the new buffer allocation. Therefore, the cache lines in the new buffer allocation need merely be invalidated by a requesting processor and does not require any further review prior to issuance of the cache invalidate command. FIG. 1 is a prior art flow chart (100) illustrating a process for invalidating cache lines in a new buffer allocation. As noted above, a new buffer is allocated by a requesting processor from a prior owning processor at a defined address (102). More specifically, the allocation is done by the operating system that manages main memory by allocating and freeing portions of memory that are scheduled to run on the processor. In one embodiment, the new buffer allocation includes a size defined by a quantity of cache lines at a specified address. The quantity of cache lines in the new buffer is assigned to the variable n (104), and a counting variable i is set to zero (106). In one embodiment, the variable i is used to count the cache lines in the allocated buffer. It is then determined if the variable i is less than the quantity of cache lines n in the buffer (108). A negative response to the determination at step (108) will end the process for writing the cache lines (110). In contrast, a positive response to the determination at step (108) will result in issuance of a memory write for cache lineᵢ by the requesting processor (112) followed by communication of a remote invalidate command of cache lineᵢ to the remote processor (114). The requesting processor then waits to receive an acknowledgment of completion of the invalidate for the specified cache lineᵢ (116). The requesting processor cannot write to the cache line until the remote invalidate of the cache lineᵢ has completed.

Once the requesting processor has received acknowledgment of completion of the cache lineᵢ invalidate, the variable i is incremented (118), and the write process returns to step (108) until each cache line in the new buffer allocation has been written. For each cache line, a thread writing to the new buffer at the line address must wait for a remote-cache invalidate instruction to complete in order to allow a new write to the cache line from a requesting thread. In other words, each cache line in the newly allocated buffer from a remote processor is invalidated sequentially on a first reference to each cache line. Each cache line invalidate is obtained from the remote processor that previously owned the cache line through the operating system. Therefore the cache invalidate is a non-local procedure as it is a communication between a local processor and a remote processor. Accordingly, the process for invalidating multiple cache lines in a remote buffer allocation is expensive in terms of increased latency for individually invalidating each cache line as well as remote calls across the network.

Therefore, there is a need for a computer system comprising multiple processors to support high-performance parallel programs to invalidate multiple cache lines in a newly allocated buffer from a remote processor in a single instruction to mitigate the expense associated with invalidating a single cache line at a time. The novel remote invalidate method presented herein promotes increased efficiency for invalidating cached data in a new buffer allocation, thereby reducing latency and producing system level performance benefits.

### SUMMARY OF THE INVENTION

This invention comprises a method, system, and article for allocating a buffer in a multiprocessor computing system.

In one aspect of the invention, a method is provided for allocating a buffer in a multiprocessor computing system. A computer system is configured with multiple processors. A first processor in the system requests a remote buffer allocation, with the remote buffer having multiple cache lines. Before the first processor can write to at least one of the cache lines in the buffer for the first time, a single cache line invalidate command is issued to invalidate at least two cache lines in the allocated remote buffer. Once the first processor receives an acknowledgment of invalidation of the cache lines, the first processor can write to at least one of the invalidated cache lines and a cache line in the allocated remote buffer.

In another aspect of the invention, a computer system is provided with a first processor in communication with a second processor across a network. A first cache manager is provided in the system and assigned to the first processor to request a remote buffer allocation from a non-local resource in the network. The remote buffer has multiple cache lines. The first cache manager issues a cache line invalidate command from the first processor to invalidate at least two cache lines in the remote buffer before the first processor writes to the cache lines for a first time. The first processor issues a write instruction to at least one of the invalidated cache lines following receipt of an acknowledgment of invalidation of the cache lines from the first cache manager.

In yet another aspect of the invention, an article is provided with a computer-readable carrier including computer program instructions configured to allocate a buffer in a multiprocessor computing system. Instructions are provided from a first processor in the system to request a remote buffer allocation. The remote buffer has multiple cache lines. In addition, instructions are provided to issue a single remote invalidate instruction to invalidate at least two cache lines in the remote buffer allocation prior to the first processor writes to at least one of the cache lines in the remote buffer for a first time. Instructions are provided from the first processor to write to at least one of the invalidated cache lines following receipt of an acknowledgment of invalidation of the cache lines.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart of a prior art process for allocating and writing a remotely cached buffer.

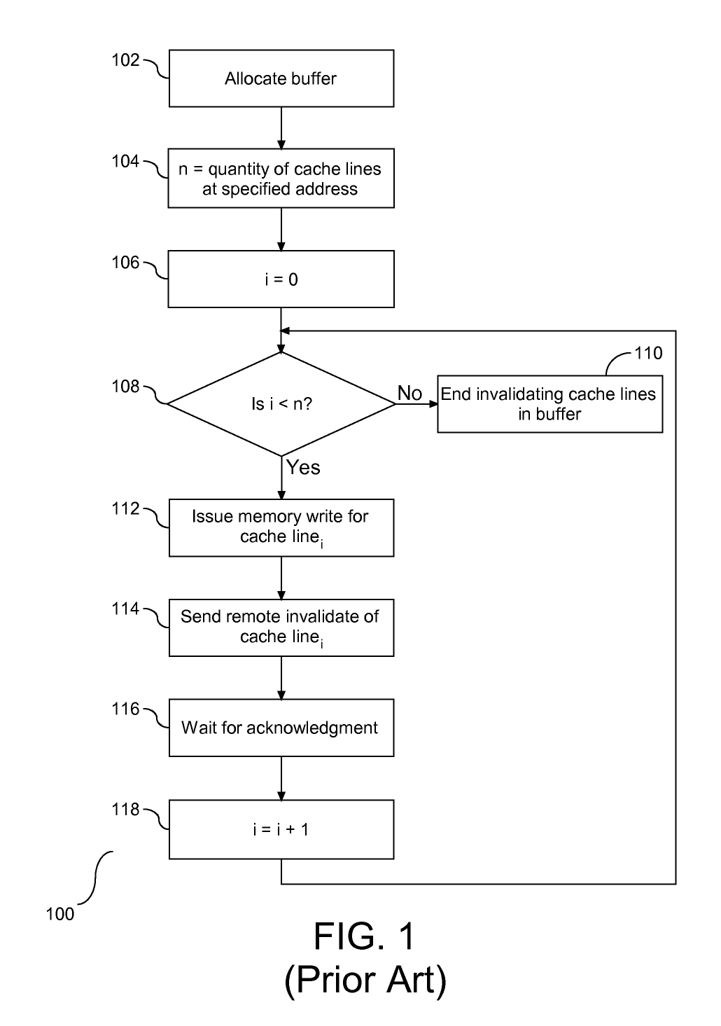

FIG. 2 is a flow chart for invalidating cache lines in a buffer allocation according to the preferred embodiment of this invention, and is suggested for printing on the first page of the issued patent.

FIG. 3 is a block diagram of a multiprocessor computer system configured with a buffer manager to manage buffer allocation and associated cache line invalidation.

### DESCRIPTION OF THE PREFERRED EMBODIMENT

### Overview

A process and/or system are provided wherein a processor in a multiprocessor computer system may allocate a new buffer using memory not present in the processor's local cache, i.e. remote memory. The cache lines of the buffer must be invalidated through a remote memory management processor and the invalidation must be completed before a thread can make a reference, i.e. write, to the cache line for the first time in the new buffer allocation. Multiple cache lines are invalidated in a single remote cache invalidate request. Accordingly, multiple calls across the network to a remote memory cache manager to acknowledge invalidation of each cache line are mitigated by enabling a range of cache lines to be invalidated in a single communication.

### Technical Details

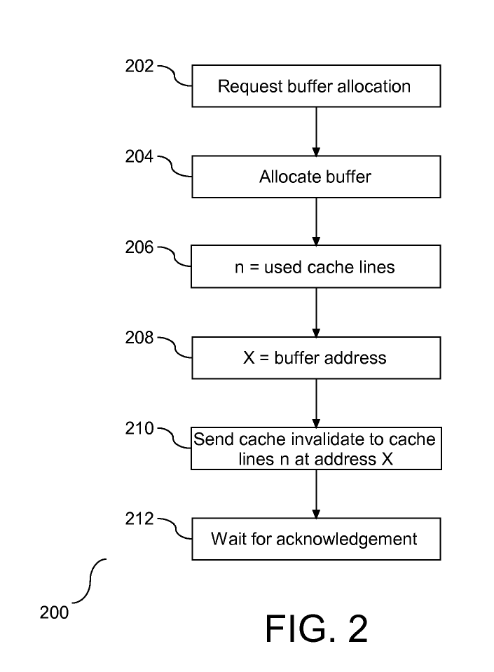

FIG. 2 is a flow chart (200) illustrating a process for allocating a new buffer from a remote processor and for invalidating cache lines in the buffer. Initially, a processor requests the new buffer allocation (202). A buffer is a region of memory used to temporarily hold data. In one embodiment, a multiprocessing system may be configured with a quantity of processors and a quantity of buffers, wherein the processors are assigned temporary ownership of the buffers to support processing of data. Buffers migrate between processors based upon demand. Following the request at step (202) and based upon availability of the allocation of a buffer to the requesting processor, a buffer which is no longer required to support the tasks of an owning processor remote from the requesting processor is allocated to the requesting processor (204). In one embodiment, the buffer allocation is managed by the firmware or by the operating system. A buffer is available when a processor in the system does not require the buffer to support its tasks. An allocated buffer may include a quantity of cache lines therein. The quantity of used cache lines is assigned to the integer n (206). In one embodiment the cache line size may be fixed by the associated hardware as a set quantity of bytes. The number of cache lines in the allocated buffer is determined by the size of the buffer divided by the number of bytes in a cache line. Similarly, the new buffer allocation is assigned to an address, and the address is assigned to the variable X (208). The new buffer allocation is new with respect to the requesting processor. However, the memory associated with the new buffer allocation exists within the computer system and is merely transferred by the operating system from an owning processor to the requesting processor. Since the new buffer allocation is in one sense a transfer of a buffer across the network, the buffer may contain cached data from the previously owning processor. The previously cached data is irrelevant to the prior owning processor as the buffer is available to be owned by the requesting processor. Similarly, the previously cached data is not needed by the requesting processor. In order to properly use the allocated buffer, the requesting processor needs to invalidate the cache lines in the buffer from the prior owning processor. The invalidation clears the cache lines and enables the requesting processor to store data in the buffer.

To invalidate the cache lines of the buffer, a single remote invalidate command is issued by the requesting processor for all of the n cache line at address X of the new buffer allocation (210). The requesting processor then waits for acknowledgment of the cache lines invalidation (212). Once the acknowledgment is received, all of the cache lines are invalidated and available to the requesting processor. A single command is issued to invalidate the cache lines from the remote cache manager. In one embodiment, the invalidate command may designate a quantity of cache lines less than all of the cache lines in the buffer allocation to be invalidated. The single invalidate command requires only a single acknowledgment of the invalidation from the remote processor. In one embodiment, where the cache invalidate command includes multiple cache lines but does not include all n cache lines, the quantity of cache invalidate commands is reduced in comparison to a sequence of individual cache line invalidates. Following receipt of the acknowledgment of the invalidation of the cache lines, the requesting processor may write data to the invalidated cache lines in the buffer. Accordingly, multiple cache line invalidates are completed with a single remote invalidate command through designation of the quantity of cache lines, n, and the address, X, of the new buffer allocation or a reduced quantity of remote invalidate commands.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For purposes of this description, a computer-usable or computer readable medium can be any apparatus that can contain, store, communicate, propagate, or transport the program for use by or in connection with the instruction execution system, apparatus, or device.

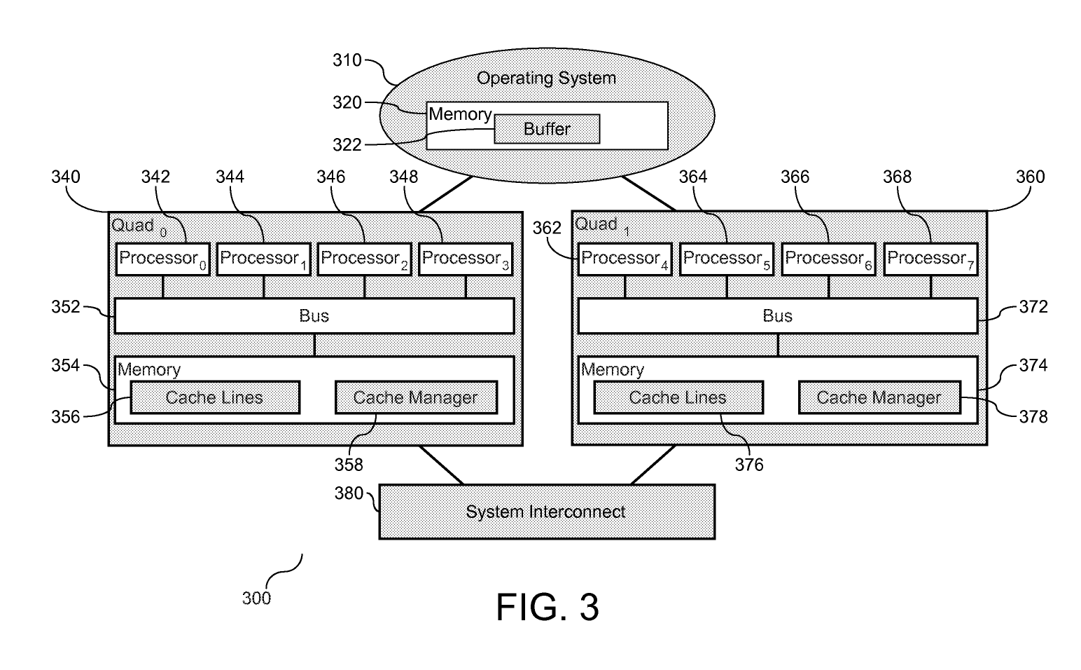

Similarly, in one embodiment the invention is implemented in hardware. FIG. 3 is a block diagram (300) illustrating a buffer allocation and cache line invalidation tool in a NUMA computer system. The illustration shows an operating system (310) with memory (320) and a buffer (322). The operating system is in communication with two quads of processors (340) and (360), respectively, in communication with a system interconnect (380). Although only two quads are shown herein, in one embodiment, the operating system (310) may be in communication with a single quad or with a larger quantity of quads. Accordingly, the invention should not be limited to an operating system in communication with only two quads. The operating system (310) views the entire system as a single entity and manages all processors, memory, and peripherals. From the operating system perspective, all the memory is one logical address space and it will allocate and free buffers within it. These buffers may have pieces resident in any of the quads, such as data in the cache lines. The cache lines and cache managers work at the hardware level to provide the single-memory view to the operating system (310). Each quad (340) and (360) includes four processors. As such, the first quad (340) includes processors (342), (344), (346), and (348). Similarly, the second quad (360) includes processors (362), (364), (366), and (368). Each quad shares a bus and memory. In the first quad (340) the processors share bus (352) and memory (354). Similarly, in the second quad (360) the processors share bus (372) and memory (374). In the example shown herein, the first quad (340) has cache lines (356) in a region of it's memory (354) to temporarily hold data, and the second quad (360) has cache lines (376) in a region of it's memory (374) to temporarily hold data. Each of the quads (340) and (360) have a cache manager (358) and (378), respectively, to manage shared memory between the quads and invalidation of cache lines. The cache manager in each quad communicates with other cache managers on other quads to determine which one has valid data for a particular address. The communication takes place over the system interconnect (380) between the quads (340) and (360).

The system interconnect (380) has firmware (not shown) to implement a communication protocol between the quad (340) and (360). The firmware is programmed to define a command to allow specification of multiple cache lines in relation to a remote buffer allocation. Similarly, the operating system (310) is modified with a new hardware register (not shown) to accept a new command to support the modified system interconnect firmware. Accordingly, both the system interconnect (380) and the operating system (310) are modified to support a communication protocol that may invalidate multiple cache lines in a remote buffer allocation in a single communication.

Each of the cache managers (358) and (378), also known as buffer manager, may request a remote buffer allocation from a non-local resource in the network at such time as a remote buffer allocation becomes necessary. The remote buffer includes multiple cache lines that may be utilized to store cache data on a temporary basis. At such time as a remote buffer allocation is requested, the cache manager in receipt of the allocation must invalidate the cache lines before the cache lines can be utilized for the tasks required by the requesting processor. A single cache invalidate command may be issued by the cache manager associated with the requesting processor to invalidate multiple cache lines before the requesting processor can write to the cache lines in the buffer allocation for the first time.

In the example shown herein, the cache managers (358) and (378) are shown residing in memory (354) and (374), respectively, and utilize instructions in a computer readable medium to manage shared memory. The cache manager (358) communicates with the processors (342), (344), (346), and (348) in the first quad (340), and the cache manager (378) communicates with the processors (362), (364), (366), and (368) in the second quad (360). Similarly, in one embodiment, the cache managers (358) and (378) may reside as hardware tools external to their respective memory (354) and (374), or they may be implemented as a combination of hardware and software in the computer system. Although the system shown in FIG. 3 is a NUMA system with processors grouped into quads, the invention may be applied to other forms of multiprocessing distributed computer systems and should not be limited to a NUMA system. Accordingly, the cache managers (358) and (378) may be implemented as a software tool or a hardware tool to facilitate management of cache lines in a multiprocessor computer system.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include but are not limited to a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over The Prior Art

A remote invalidate command is issued from a requesting processor to invalidate a plurality of cache lines of a buffer in a single command. The remote invalidate command includes a quantity of cache lines to be invalidated and a starting address pertaining to the starting cache line address in the buffer. By specifying invalidation of multiple cache lines in a single invalidate command, the quantity of calls across the network are reduced. In addition, since a quantity of cache lines are invalidated with a single command, the buffer may accept a write from a requesting thread to one of the invalidated cache lines without delay. Accordingly, system performance is enhanced by reducing the quantity of cache line invalidate commands across the network in response to a new buffer allocation.

### Alternative Embodiments

It will be appreciated that, although specific embodiments of the invention have been described herein for purposes of illustration, various modifications may be made without departing from the spirit and scope of the invention. In particular, in one embodiment firmware in communication with the processor and external to memory, or a programmable remote memory controller, may be employed to manage cache line invalidates for a buffer allocation. Similarly, in one embodiment, hardware elements of the computer system may be employed to manage invalidation of cache lines in a new buffer allocation. One or more hardware registers may be assigned the following: a starting address for the cache lines in the buffer to be invalidated, an ending address, and/or the quantity of cache lines to be invalidated. The hardware registers are then employed to process the cache line invalidates. As has been described herein, multiple cache lines may be invalidated with a single cache line invalidate command. Accordingly, the scope of protection of this invention is limited only by the following claims and their equivalents.

We claim:

1. A method for allocating a buffer in a multiprocessor computing system, comprising:
configuring a computer system with multiple processors;
requesting a remote buffer allocation by a first processor, said remote buffer having multiple cache lines;
issuing a single cache line invalidate command to invalidate at least two cache lines in said remote buffer allocation prior to said first processor writing to at least one of said cache lines in said buffer for a first time;
receiving by said first processor an acknowledgment of invalidation of said cache lines; and
writing by said first processor to at least one of said invalidated cache lines following receipt of said acknowledgment of invalidation of the cache lines.

2. The method of claim 1, wherein the step of issuing a single cache line invalidate command to invalidate at least two cache lines in said buffer includes a range of cache lines having a starting address for a starting cache line and an ending address for an ending cache line.

3. The method of claim 2, further comprising obtaining an address for said range of cache lines for said buffer.

4. The method of claim 1, further comprising referencing a hardware register in said cache line invalidate command wherein said hardware register references multiple cache lines to invalidate said multiple cache lines.

5. The method of claim 1, wherein issuing a cache line invalidate command includes employing firmware instructions to invalidate said at least two cache lines.

6. The method of claim 1, wherein memory associated with said buffer includes valid cache entries on a second processor.

7. The method of claim 1, wherein the step of issuing a single remote cache invalidate command to invalidate at least two cache lines in said buffer includes a starting address and a number of cache lines to be invalidated.

8. A computer system comprising:
a first processor in communication with a second processor across a network;
a first cache manager assigned to said first processor to request a remote buffer allocation from a non-local resource in said network, said remote buffer having multiple cache lines;
said first cache manager to issue a cache line invalidate command from said first processor to invalidate at least two cache lines in said remote buffer prior to said first processor writing to said cache lines for a first time; and
said first processor to issue a write instruction to at least one of said invalidated cache lines following receipt of an acknowledgment of invalidation of the cache lines from said first cache manager.

9. The system of claim 8, wherein the cache line invalidate command to invalidate at least two cache lines in said buffer includes a range of cache lines having a starting address for a starting cache line and an ending address for an ending cache line.

10. The system of claim 9, further comprising an address for said range of cache lines for said buffer.

11. The system of claim 8, further comprising a hardware register including multiple cache line addresses, and said first buffer manager to reference said hardware register to invalidate said multiple cache lines.

12. The system of claim 8, wherein the cache line invalidate command includes employment of a firmware instruction to invalidate multiple cache lines.

13. The system of claim 8, wherein said cache line invalidate command to invalidate at least two cache lines in said buffer includes a starting address and a number of cache lines to be invalidated.

14. An article comprising:
a computer-readable carrier including computer program instructions configured to allocate a buffer in a multiprocessor computing system, comprising:
instructions from a first processor in said system to request a remote buffer allocation, said remote buffer having multiple cache lines;
instructions to issue a single cache line invalidate instruction to invalidate at least two cache lines in said remote buffer allocation prior to said first processor writing to at least one of said cache lines in said buffer for a first time; and
instructions from said first processor to write to at least one of said invalidated cache lines following receipt of an acknowledgment of invalidation of the cache lines.

15. The article of claim 14, wherein the cache line invalidate command to invalidate at least two cache lines in said buffer includes a range of cache lines having a starting address for a starting cache line and an ending address for an ending cache line.

16. The article of claim 15, further comprising instructions to obtain addresses for said range of cache lines for said buffer from main memory.

17. The article of claim 14, further comprising referencing a hardware register in said cache line invalidate instruction, wherein said hardware register references multiple cache lines to invalidate.

18. The article of claim 14, wherein the instructions to issue a cache line invalidate command includes employing firmware to invalidate said at least two cache lines.

19. The article of claim 14, wherein memory associated with said buffer has valid cache entries on a second processor.

20. The article of claim 14, wherein the instructions to issue a cache line invalidate instruction to invalidate at least two cache lines in said buffer includes a starting address and a number of cache lines to be invalidated.
